(19) United States
(12) Patent Application Publication
(10) Pub. No.: US 2007/0115976 A1
(43) Pub. Date: May 24, 2007

(54) Address management system, address management method and address management program of image forming apparatus

(75) Inventor: Tetsuya Yoshioka, Osaka (JP)

Correspondence Address: MCDERMOTT WILL & EMERY LLP, 600 13TH STREET, N.W., WASHINGTON, DC, 20005-3096, US

(73) Assignee: KYOCERA MITA CORPORATION

(21) Appl. No.: 11/585,829

(22) Filed: Oct. 25, 2006

(30) Foreign Application Priority Data
Oct. 25, 2005 (JP) 2005-309524
Oct. 25, 2005 (JP) 2005-309525

(51) Int. Cl. H04L 12/56; H04L 12/28

(52) U.S. Cl. 370/390

(57) ABSTRACT

The present invention is an address management system (14) of an image forming apparatus comprising multi send function to be able to send the same data at once by using multiple transmitting means at a unit of a group plural addresses are entered comprising: an address entry means (15) for entering addresses to the group, an original group selection means (16) for selecting an original group to be copied from the existing groups which addresses are entered by the address entry means, a copy group selection means (17) for selecting a copy group to copy the addresses of the original group selected by the original group selection means.

### CROSS-REFERENCE TO RELATED APPLICATION

This application is based on applications No. 2005-309524 and No. 2005-309525 filed in Japan, the content of which is incorporated hereinto by reference.

### FIELD OF THE INVENTION

The present invention relates to an address management system, an address management method and an address management program of an image forming apparatus comprising multi send function to be able to send the same data to plural addresses at once by using multiple transmitting means.

### BACKGROUND OF THE INVENTION

Recently, in the field of an image forming apparatus such as a facsimile machine, a combination machine and the like, an image forming apparatus comprising what is called multi send function to be able to send the same data at once by using multiple transmitting means such as telephone line, LAN (Local Area Network) and the like, to plural addresses such as a facsimile terminal address, a network facsimile terminal address, a e-mail address, a SMB (Server Message Block) folder address, a FTP (File Transfer Protocol) folder address and the like is utilized.

Such an image forming apparatus comprises an address management system such as what is called an address book to manage addresses. The address management system sends the same data read by a scanner at once via the e-mail, the facsimile and the like to each address entered into the selected group (See Japanese Patent No. 3569925).

However, in the case of entering a group newly at the above-mentioned prior address management system of the image forming apparatus, the operation for entering each address to compose the group has to be carried out repeatedly. Furthermore, in the case of editing addresses of the existing group, the operation for entering or deleting each address to compose the group has to be carried out repeatedly after selecting the group to edit. Therefore, there is a problem that the entry or edit operation is very diffictult.

In addition, at the above-mentioned prior address management system of the image forming apparatus, it is difficult for a sender to find out an entry error or a selection error of the data related to addresses beforehand at the time of grouping addresses together. Therefore, it is undesirable in the light of the data leakage prevention since there are risks to send the data to the wrong addresses or to be unable to send the data to the desirable addresses.

In order to overcome the above problems, the object of the present invention is to provide an address management system, an address management method and an address management program of an image forming apparatus to be able to make entry and edit operation of the group simple and to send the data to the desirable addresses securely to by giving the opportunity to confirm the addresses for the sender compulsorily before sending the data to prevent the data leakage.

### SUMMARY OF THE INVENTION

In order to achieve the above objects, the present invention is an address management system of an image forming apparatus comprising multi send function to be able to send the same data at once by using multiple transmitting means at a unit of a group plural addresses are entered comprising: an address entry means for entering addresses to the group, an original group selection means for selecting an original group to be copied from the existing groups which addresses are entered by the address entry means, a copy group selection means for selecting a copy group to copy the addresses of the original group selected by the original group selection means.

The present invention may be the address management system of the image forming apparatus wherein the copy group selection means comprises a new group entry means for copying addresses of the original group selected by the original group selection means to a group to be newly entered.

The present invention may be the address management system of the image forming apparatus wherein the copy group selection means comprises an existing group edit means for copying and adding addresses of the original group selected by the original group selection means to the existing group.

The present invention is an address management system of an image forming apparatus comprising multi send function to be able to send the same data to plural addresses at once by using multiple transmitting means comprising: an address entry means for entering the addresses, an address selection means for selecting an address to send from the addresses entered by the address entry means, a address confirmation means for displaying an address confirmation screen to indicate the selected address by a dialog box before sending the data to the address after selecting the address to send by the address selection means.

The present invention may be the address management system of the image forming apparatus according to claim 5 further comprising: an address change means for executing the operation of selection or cancellation of selection of the address to send from the address confirmation screen.

The present invention is an address management method of an image forming apparatus comprising multi send function to be able to send the same data at once by using multiple transmitting means at a unit of a group which plural addresses are entered comprising: a step for entering addresses to the group by an address entry means, a step that an original group selection means selects a original group to be copied from the existing groups which addresses are entered by the address entry means, a step that a copy group selection means selects a copy group to copy the addresses of the original group selected by the original group selection means.

The present invention is an address management method of an image forming apparatus comprising multi send function to be able to send the same data to plural addresses at once by using multiple transmitting means comprising: a step for entering the addresses by an address entry means, a step for selecting an address to send from the addresses entered by the address entry means, a step for displaying an address confirmation screen to indicate the selected address by a dialog box before sending the data to the address after selecting the address to send.

The present invention may be the address management method of the image forming apparatus according to claim 8 further comprising: a step for executing the operation of selection or cancellation of selection of the address to send from the address confirmation screen.

The present invention is a computer-readable address management program of an image forming apparatus for allowing the computer to perform the above-mentioned each step.

According to the present invention, it is possible to save labor to enter or delete each address to compose the group at the time of making up the group since it is possible to make up new groups or existing groups by copying addresses entered in the existing groups. Therefore, it is possible to make entry or edit operation of groups simple.

Furthermore, it is possible for a sender to find out an entry error or a selection error of the data related to addresses beforehand easily and securely by the address confirmation screen since the address confirmation screen is displayed compulsorily before sending the data. Therefore, it is possible to send the data to the desirable addresses securely and prevent the data leakage.

### BRIEF DESCRIPTION OF THE DRAWINGS

FIG. 1 is a block view shown configuration of an image forming apparatus in an embodiment of the present invention;

FIG. 2 is a function block view shown configuration of the address management system of the image forming apparatus according to the embodiment of the present invention;

FIG. 3 is a view shown an original group selection screen of the address management system of the image forming apparatus according to the embodiment of the present invention;

FIG. 4 is a view shown a new copy group entry screen of the address management system of the image forming apparatus according to the embodiment of the present invention;

FIG. 5 is a view shown an original existing group selection screen of the address management system of the image forming apparatus according to the embodiment of the present invention;

FIG. 6 is a view shown an address selection screen of an address management system of an image forming apparatus according to an embodiment of the present invention; and

FIG. 7 is a view shown an address confirmation screen of the address management system of the image forming apparatus according to the embodiment of the present invention.

### DESCRIPTION OF THE PREFERRED EMBODIMENT

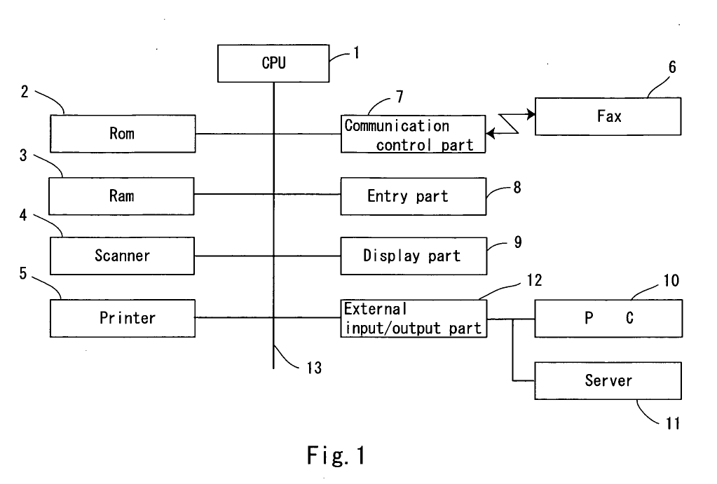

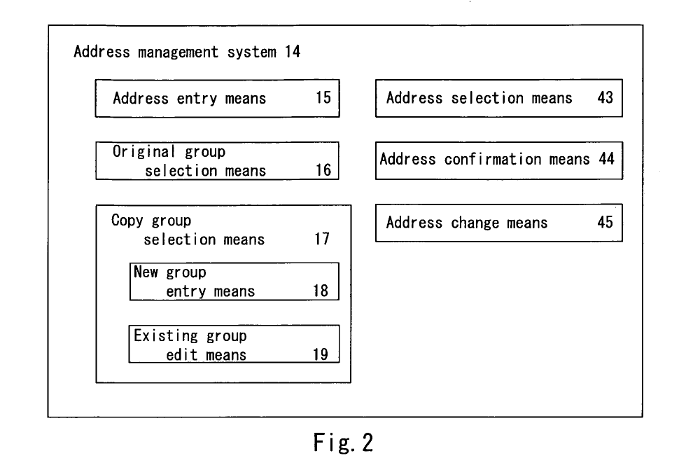

We will now describe an embodiment of the present invention with reference to the accompanying drawings. The FIG. 1 is a block view shown configuration of an image forming apparatus in the present invention, and the FIG. 2 is a function block view shown configuration of the address management system of the image forming apparatus according to the present invention.

As shown on the FIG. 1, the image forming apparatus according to the embodiment of the present invention comprises a CPU (Central Processing Unit) 1 for controlling each element of the image forming apparatus, a ROM (Read Only Memory) 2 for storing control program to run on a computer, a RAM (Random Access Memory) 3 for storing all kinds of data and program temporarily, a scanner 4 for reading image data from documents, a printer 5 for putting papers into print, communication control part 7 for communicating with a facsimile machine (FAX) 6 via telephone line and the like, entry part 8 such as a mouse or a keyboard, a display part 9 such as a liquid crystal display, and external input/output part 12 for communicating with all kinds of external devices such as a personal computer (PC) 10 or a server 11 and the like via LAN and the like, which are connected each other via bus 13. The address management program installed on the image forming apparatus runs on the CPU 1 and after-mentioned address management system 14 functions

As shown on the FIG. 2, the address management system 14 comprises an address entry means 15 for entering addresses to the group, an original group selection means 16 for selecting an original group to be copied from the existing groups which addresses are entered by the address entry means 15, and a copy group selection means 17 for selecting a copy group to copy the addresses of the original group selected by the original group selection means 16. The copy group selection means 17 further comprises a new group entry means 18 for copying addresses of the original group selected by the original group selection means 16 to a group to be newly entered, and an existing group edit means 19 for copying and adding addresses of the original group selected by the original group selection means 16 to the existing group.

An address management system 14 comprises an address selection means 43 for selecting an address to send from the addresses entered by the address entry means 15, a address confirmation means 44 for displaying an address confirmation screen to indicate the selected address by a dialog box before sending the data read by the scanner 4 to the address after selecting the address to send by the address selection means 43, an address change means 45 for executing the operation of selection or cancellation of selection of the address to send from the address confirmation screen.

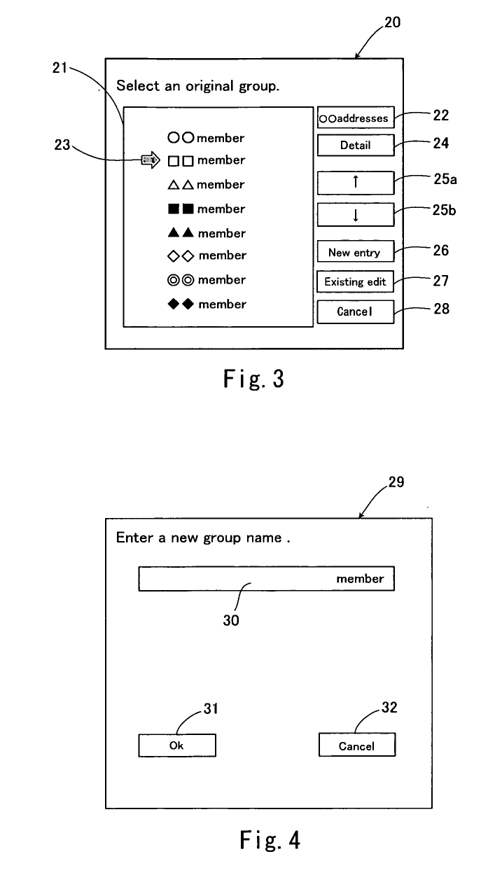

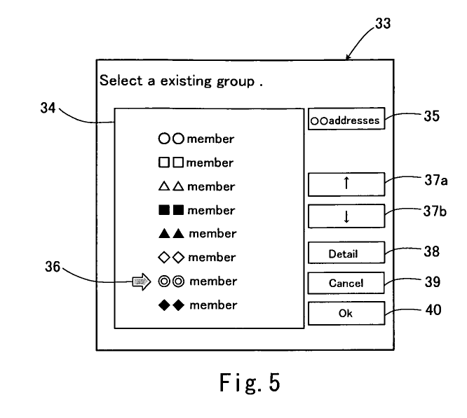

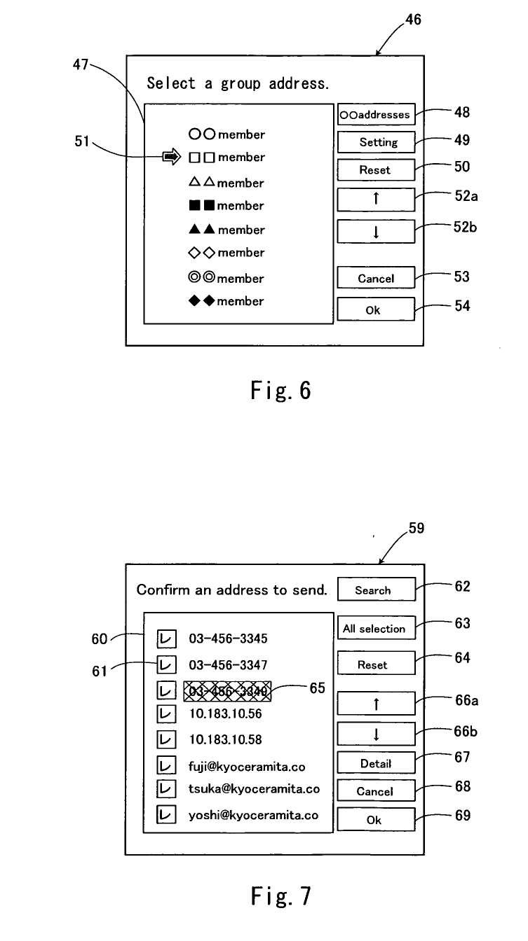

Next, we will describe the operation of the present invention. The FIG. 3 is a view shown a group selection screen of the address management system of the image forming apparatus according to the embodiment of the present invention, the FIG. 4 is a view shown a new group entry screen of the address management system of the image forming apparatus, the FIG. 5 is a view shown an existing group selection screen of the address management system of the image forming apparatus, the FIG. 6 is a view shown an address selection screen of the address management system of the image forming apparatus, the FIG. 7 is a view shown an address confirmation screen of the address management system of the image forming apparatus.

Firstly, when entering data related to addresses from the entry part 8 and grouping the addresses together randomly, the address entry means 15 stores and enters the each address in the ROM 2 at a unit of a group. The data related to addresses at this time include not only FAX addresses, network FAX addresses, e-mail addresses, SMB folder addresses, FTP folder addresses and the like but also names, offices, addresses of senders and the like.

Next, when carrying out the predetermined operation from the entry part 8 under the condition of grouping each address together like this, the group selection screen 20 is displayed on the display part 9 as shown on the FIG. 3. A list 21 of groups entered in the ROM 2 is displayed on the group selection screen 20. In addition, a number display part 22 for displaying number of addresses entered in each group, a detail button 24 for displaying all data related to the group designated by a cursor 23 (an arrow in the FIG. 3), ups and downs arrow buttons 25a, 25b for moving the cursor 23 up and down, a new entry button 26 for entering a new group by selecting the group designated by the cursor 23 as the original group, a existing edit button 27 for editing the existing group, a cancel button 28 for canceling the operation of selection of the original group are placed at the adjacent area to the list 21 of groups in the group selection screen 20.

On the group selection screen 20 as the above, when operating the ups and downs arrow button 25a, 25b to match the cursor 23 with the name of the desirable existing group (“□□ member” in the FIG. 3) to select the new entry button 26, the original group selection means 16 selects the existing group designated by the cursor 23 as the original group. After that, a new group entry screen 29 is displayed on the display part 9, and an entry space 30 for entering a new group name, an OK button 31 and a cancel button 32 are displayed on the new group entry screen, as shown on the FIG. 4

Next, on the new group entry screen 29, when entering a new group name into the entry space 30 and selecting the OK button 31 from the entry part 8 , the new group entry means 18 of the copy group selection means 17 copies all addresses entered in the existing group selected by the original group selection means 16 to make a new group. Furthermore, the new group entry means 18 put the name to the new group, and store and enters the new group in the ROM 2.

On the other hand, on the group selection screen 20 as the above, when operating the ups and downs arrow button 25a, 25b to match the cursor 23 with the name of the desirable group (“□□ member” in the FIG. 3) to select the existing edit button 27, the original group selection means 16 selects the existing group designated by the cursor 23 as the original group. After that, a existing group selection screen 33 is displayed on the display part 9 as shown on the FIG. 5.

A list 34 of existing groups is displayed on the existing group selection screen 33 to be copied. In addition, a number display part 35 for displaying number of addresses entered in each group, ups and downs arrow buttons 37a, 37b for moving the cursor 36 (an arrow in the FIG. 5) up and down, a detail button 38 for displaying all data related to the group designated by a cursor 36, a cancel button 39 for canceling the operation of selection of the copy group, a OK button 40 for confirming to select the group designated by the cursor 36 as the copy group are placed at the adjacent area to the list 34 of existing groups in the existing group selection screen 33.

On the group selection screen 33 at the side to copy, when operating the ups and downs arrow button 37a, 37b to match the cursor 36 with the name of the desirable group (“⊚⊚member in the FIG. 5) to select the OK button 40, the existing group edit means 19 of the copy group selection means 17 copies and adds all addresses entered in the existing group selected by the original group selection means 16 to the existing group designated by the cursor 36, and stores and enters the existing group in the ROM 2.

When carrying out the predetermined operation from the entry part 8, the address selection screen 46 is displayed on the display part 9 as shown on the FIG. 6. A list 47 of groups entered in the ROM 2 is displayed on the address selection screen 46. In addition, a number display part 48 for displaying number of addresses entered in each group, a setting button 49 for setting groups, a reset button 50 for resetting the groups, ups and downs arrow buttons 52a, 52b for moving the cursor 51 (an arrow in the FIG. 6) up and down, a cancel button 53 for canceling the operation of selection of the group, an OK button 54 for carrying out to select the group designated by the cursor 51 are placed at the adjacent area to the list 47 of groups in the address selection screen 46.

On the address selection screen 46 as the above, when operating the ups and downs arrow button 52a, 52b to match the cursor 51 with the name of the desirable group (“□□member” in the FIG. 6) to select the OK button 54, the address confirmation screen 59 is displayed on the display part 9 by a dialog box as shown on the FIG. 7. A list 60 of addresses entered in the group selected from the address selection screen 46 is displayed on the address confirmation screen 59. Furthermore, check boxes 61 are placed at the head of each address of this list 60, and a check mark can be input in the check box of the selected address.

In addition, a search button 62 for searching an address, all selection button 63 for selecting all addresses entered in the selected group, a reset button 64 for resetting an address entered in the selected group, ups and downs arrow buttons 66a, 66b for moving the shading part 65 up and down to designate a group, a detail button 67 for displaying all data related to the address designated by the shading part 65, a cancel button 68 for canceling the operation of selection of the address, an OK button 69 for confirming to send to the address indicated by the check mark in the check box 61 are placed at the adjacent area to the list 60 of addresses in the address confirmation screen 59.

On the address confirmation screen 59 as the above, when selecting the OK button 69, the same data read by the scanner 4 send to the addresses indicated by check mark in the check box 61 of the list 60 of addresses at once.

Furthermore, when selecting the all selection button 63 from the address confirmation screen 59, the address change means 45 enters the check mark in all check boxes 61, and then operates the ups and downs arrow buttons 66a, 66b to move the shading part 65 to the desirable address. When selecting the reset button 64, the address change means 45 deletes the check mark in the check box 61 of the desirable address to reset selection of the address. Thus, it is possible to carry out the operation of selection or reset of the address to send by the address change means 45 from the above address confirmation screen 59.

According to the embodiment of the present invention as the above, it is possible to save labor to enter or delete each address to compose the group at the time of making up the group since it is possible to make up new groups or existing groups by copying addresses entered in the existing groups. Therefore, it is possible to make entry or edit operation of groups simple.

Furthermore, it is possible for a sender to find out an entry error or a selection error of the address beforehand easily and securely by the address confirmation screen 59 since the address confirmation screen 59 is displayed by a dialog box compulsorily before sending the data. Therefore, it is possible to send the data to the desirable addresses securely and prevent the data leakage.

Although the embodiment of the present invention has been described in the image forming apparatus comprising multi send function, it is to be understood by those skilled in the art that the present invention can be applicable to the other image forming apparatus, such as one comprising what is called simultaneous function to send the same data to the plural addresses at once by using single transmitting means or one without the above multi send function or simultaneous function and the like.

What is claimed is:

1. An address management system of an image forming apparatus comprising multi send function to be able to send the same data at once by using multiple transmitting means at a unit of a group which plural addresses are entered comprising:
an address entry means for entering addresses to the group,
an original group selection means for selecting an original group to be copied from the existing groups which addresses are entered by the address entry means,
a copy group selection means for selecting a copy group to copy the addresses of the original group selected by the original group selection means.

2. The address management system of the image forming apparatus according to claim 1 wherein the copy group selection means comprises a new group entry means for copying addresses of the original group selected by the original group selection means to a group to be newly entered.

3. The address management system of the image forming apparatus according to claim 1 wherein the copy group selection means comprises an existing group edit means for copying and adding addresses of the original group selected by the original group selection means to the existing group.

4. The address management system of the image forming apparatus according to claim 2 wherein the copy group selection means comprises an existing group edit means for copying and adding addresses of the original group selected by the original group selection means to the existing group.

5. An address management system of an image forming apparatus comprising multi send function to be able to send the same data to plural addresses at once by using multiple transmitting means comprising:
an address entry means for entering the addresses,
an address selection means for selecting an address to send from the addresses entered by the address entry means,
a address confirmation means for displaying an address confirmation screen to indicate the selected address by a dialog box before sending the data to the address after selecting the address to send by the address selection means.

6. The address management system of the image forming apparatus according to claim 5 further comprising:
an address change means for executing the operation of selection or cancellation of selection of the address to send from the address confirmation screen.

7. An address management method of an image forming apparatus comprising multi send function to be able to send the same data at once by using multiple transmitting means at a unit of a group which plural addresses are entered comprising:
a step for entering addresses to the group by an address entry means,
a step that an original group selection means selects a original group to be copied from the existing groups which addresses are entered by the address entry means,
a step that a copy group selection means selects a copy group to copy the addresses of the original group selected by the original group selection means.

8. An address management method of an image forming apparatus comprising multi send function to be able to send the same data to plural addresses at once by using multiple transmitting means comprising:
a step for entering the addresses by an address entry means,
a step for selecting an address to send from the addresses entered by the address entry means,
a step for displaying an address confirmation screen to indicate the selected address by a dialog box before sending the data to the address after selecting the address to send.

9. The address management method of the image forming apparatus according to claim 8 further comprising:
a step for executing the operation of selection or cancellation of selection of the address to send from the address confirmation screen.

10. A computer-readable address management program of an image forming apparatus for allowing the computer to perform each step according to claim 7.

11. A computer-readable address management program of an image forming apparatus for allowing the computer to perform each step according to claim 8.

12. A computer-readable address management program of an image forming apparatus for allowing the computer to perform each step according to claim 9.
